(19) United States
(12) Patent Application Publication
(10) Pub. No.: US 2024/0212214 A1
(43) Pub. Date: Jun. 27, 2024

(54) DECODER, IMAGE PROCESSING DEVICE, AND OPERATING METHOD OF THE IMAGE PROCESSING DEVICE

(71) Applicant: SAMSUNG ELECTRONICS CO., LTD., Suwon-si (KR)

(72) Inventors: Wonseok LEE, Suwon-si (KR); Kyungil Kim, Suwon-si (KR)

(73) Assignee: SAMSUNG ELECTRONICS CO., LTD., Suwon-si (KR)

(21) Appl. No.: 18/392,713

(22) Filed: Dec. 21, 2023

(30) Foreign Application Priority Data
Dec. 26, 2022 (KR) 10-2022-0184945
May 9, 2023 (KR) 10-2023-0059904

(51) Int. Cl. G06T 9/00

(52) U.S. Cl. CPC G06T 9/00

(57) ABSTRACT

An image processing device includes an interface configured to receive compressed data obtained by compressing image data corresponding to an output of at least one pixel and a decoder configured to generate at least two different pieces of compensation data based on loss data included in the compressed data and generate decompressed data by decompressing the compressed data based on any one piece of compensation data among the at least two different pieces of compensation data, where the loss data corresponds to data lost due to compression of the image data.

### CROSS-REFERENCE TO RELATED APPLICATIONS

This application is based on and claims priority to Korean Patent Application No. 10-2023-0059904, filed on May 9, 2023, in the Korean Intellectual Property Office, and Korean Patent Application No. 10-2022-0184945, filed on Dec. 26, 2022, the disclosures of which are incorporated by reference herein in their entireties.

### BACKGROUND

### 1. Field

Example embodiments of the disclosure relate to a decoder and an image processing device for generating decompressed data by decompressing compressed data obtained by compressing image data.

### 2. Description of Related Art

Image compression may refer to a process of generating, based on image data, compressed data having a smaller size than the image data. Image decompression may refer to a process of generating a decompressed image by decompressing the compressed data. Decompressed data may indicate the same value as the image data or a different value from the image data depending on a decompression method. Although compensation methods have been proposed to reduce the difference between the image data and the decompressed data, related art methods have limitations in reducing the difference between the image data and the decompressed data.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide a decoder, an image processing device, and an operating method of the image processing device, for reducing the difference between a plurality of pieces of image data and a plurality of pieces of decompressed data corresponding thereto.

One or more example embodiments further provide a decoder, an image processing device, and an operating method of the image processing device, by which an average offset of a plurality of pieces of decompressed data corresponding a plurality of pieces of image data may be reduced.

Additional aspects will be set forth in part in the description which follows and, in part, will be apparent from the description, or may be learned by practice of the presented embodiments.

According to an aspect of an example embodiment, an image processing device may include an interface configured to receive compressed data obtained by compressing image data corresponding to an output of at least one pixel and a decoder configured to generate at least two different pieces of compensation data based on loss data included in the compressed data and generate decompressed data by decompressing the compressed data based on any one piece of compensation data among the at least two different pieces of compensation data, where the loss data corresponds to data lost due to compression of the image data.

According to an aspect of an example embodiment, an operating method of an image processing device may include receiving compressed data including loss data corresponding to data lost due to compression of image data, generating at least two different pieces of compensation data based on the loss data, generating a random number, selecting any one piece of compensation data from among the at least two different pieces of compensation data based on the random number, and generating decompressed data based on the selected one piece of compensation data.

According to an aspect of an example embodiment, a decoder may include a compensation module configured to receive compressed data including loss data, and generate first compensation data and second compensation data based on the loss data, a random number generation module configured to generate a random number based on the loss data, and a selection module configured to select any one piece of compensation data from among the first compensation data and the second compensation data based on the random number, where the decoder is configured to generate decompressed data based on the selected one piece of compensation data.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a diagram illustrating an image processing system according to an embodiment;

FIG. 2A is a diagram illustrating a pixel array according to an embodiment;

FIG. 2B is a diagram illustrating representative pixel values respectively corresponding to pixel groups included in the pixel array of FIG. 2A according to an embodiment;

FIGS. 3A and 3B are diagrams illustrating a method of generating compressed data and a configuration of the compressed data, according to an embodiment;

FIG. 4 is a diagram illustrating a method of generating decompressed data, according to an embodiment;

FIGS. 5A and 5B are diagrams illustrating compensation data;

FIG. 6 is a diagram illustrating a decoder according to an embodiment;

FIG. 7 is a diagram illustrating an inverse quantization module according to an embodiment;

FIGS. 8A and 8B are diagrams illustrating compensation data according an embodiment;

FIGS. 9A and 9B are diagrams illustrating complementary compensation data pairs according to an embodiment;

FIG. 10 is a flowchart illustrating a method of generating decompressed data, according to an embodiment; and

FIG. 11 is a diagram illustrating an electronic device according to an embodiment.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

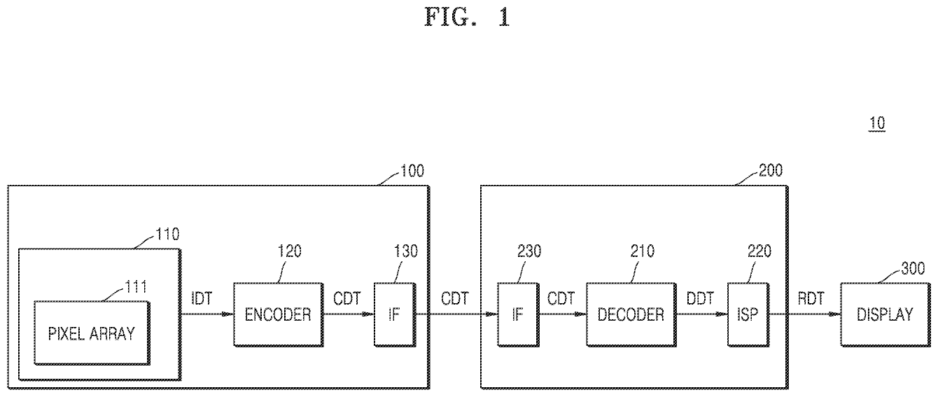

FIG. 1 is a diagram illustrating an image processing system according to an embodiment.

Referring to FIG. 1, the image processing system 10 may include a camera assembly 100, an image processing device 200, and a display 300. The camera assembly 100 may include an image sensor 110, an encoder 120, and a first interface 130 (shown as “IF” in the figures). The image sensor 110 may include a pixel array 111. The image processing device 200 may include a decoder 210, an image signal processor (ISP) 220, and a second interface 230 (shown as “IF” in the figures).

For example, the image processing system 10 may be implemented as a personal computer (PC), an Internet of Things (IOT) device, or a portable electronic device. The portable electronic device may include a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, a wearable device, and the like. In addition, the image processing system 10 may be mounted on an electronic device, such as a drone or an advanced drivers assistance system (ADAS), or an electronic device that is provided as a component of a vehicle, furniture, manufacturing equipment, a door, and various measuring devices.

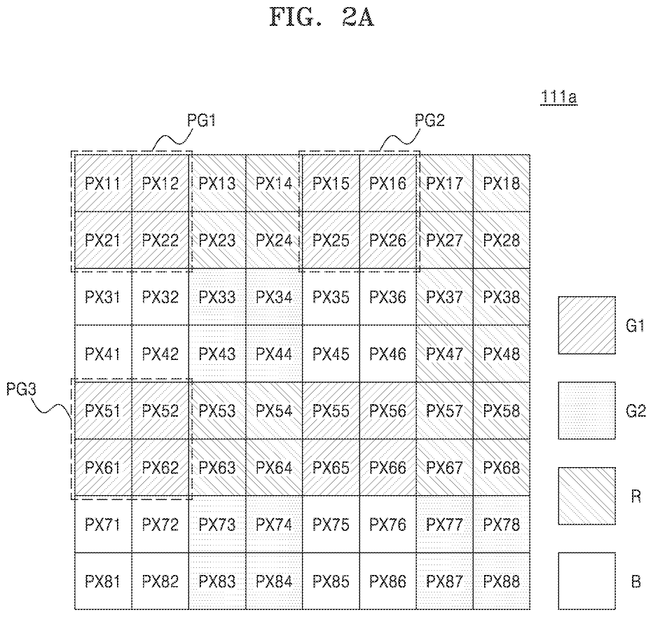

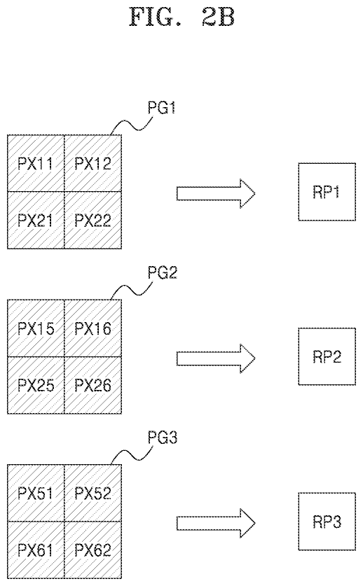

The camera assembly 100 may photograph an external subject (or object) and generate image data IDT. For example, the camera assembly 100 may convert an optical signal corresponding to a subject into an electrical signal. The conversion process may be performed by the image sensor 110 included in the camera assembly 100. The image sensor 110 may include a plurality of pixels that are two-dimensionally arranged. Each of the plurality of pixels may be a pixel corresponding to one color among a plurality of reference colors. For example, the plurality of reference colors may include red, green, and blue (RGB) or red, green, blue, and white (RGBW), and adjacent pixels among the plurality of pixels may be pixels corresponding to the same color. Descriptions in this regard are provided below with reference to FIG. 2A.

The image sensor 110 according to some embodiments may be implemented using a charge-coupled device (CCD) or a complementary metal-oxide-semiconductor (CMOS), but the image sensor 110 not limited thereto. In some embodiments, the image sensor 110 may generate the image data IDT by performing preprocessing (e.g., defective pixel correction, etc.) on a pixel signal generated by the pixel array 111 and output the image data IDT to the encoder 120.

The camera assembly 100 may compress the image data IDT using the encoder 120 to reduce power consumption according to data transmission and improve data storage efficiency. The encoder 120 may receive the image data IDT from the image sensor 110 and generate compressed data CDT by compressing the image data IDT.

The encoder 120 according to some embodiments may generate difference data by comparing the received image data IDT with reference data and generate the compressed data CDT based on the difference data. For example, the reference data may be data based on another piece of image data IDT output from the image sensor 110 at an earlier time than the aforementioned piece of image data IDT, and thus, the encoder 120 may generate the compressed data CDT based on a difference between two consecutive pieces of image data IDT.

The encoder 120 may output the compressed data CDT to the first interface 130 to transmit the compressed data CDT to the first interface 130. The first interface 130 may receive the compressed data CDT and output the compressed data CDT to the image processing device 200. For example, the first interface 130 may be implemented as a camera serial interface (CSI) based on the Mobile Industry Processor Interface (MIPI) standard. However, the type of the first interface 130 is not limited thereto, and the first interface 130 may be implemented according to various protocol standards.

The image processing device 200 may generate decompressed data DDT by decompressing the compressed data CDT received from the camera assembly 100 and output restored data RDT generated based on the decompressed data DDT to the display 300. The restored data RDT refers to data corresponding to an image to be displayed on the display 300.

The image processing device 200 may receive the compressed data CDT from the camera assembly 100 through the second interface 230. As with the first interface 130, the second interface 230 may be implemented with the MIPI standard but is not limited thereto.

The decoder 210 may receive the compressed data CDT from the second interface 230 and generate the decompressed data DDT by decompressing the compressed data CDT. For example, the compressed data CDT may be generated based on a difference between two consecutive pieces of image data IDT. The decoder 210 according to an embodiment may generate at least two pieces of compensation data based on the compressed data CDT, select any one piece of compensation data from among the at least two pieces of generated compensation data, and generate the decompressed data DDT based on the selected piece of compensation data.

Each of the encoder 120 and the decoder 210 may be implemented as software or hardware. Alternatively, each of the encoder 120 and the decoder 210 may be implemented as a combination of hardware and software, such as firmware. When the encoder 120 and the decoder 210 are implemented as software, each of the above-described operations may be implemented as programmed source code and loaded into a storage medium included in each of the camera assembly 100 and the image processing device 200. When a processor (e.g., a microprocessor) included in each of the camera assembly 100 and the image processing device 200 executes the software (i.e., executes instructions that cause one or more processors to perform requisite functions), the operations of the encoder 120 and the decoder 210 may be implemented. When the encoder 120 and the decoder 210 are implemented as hardware, the encoder 120 and the decoder 210 may include logic circuits and registers and perform each of the above-described functions based on register settings.

The ISP 220 may perform various image processing operations on the received decompressed data DDT. In some embodiments, the ISP 220 may perform, on an image signal, at least one image processing operation from among defective pixel correction, lens distortion correction, color gain, digital gain, shading correction, gamma correction, denoising, and sharpening. For example, the ISP 220 may perform digital gain on the decompressed data DDT corresponding to a low-illuminance image. The overall brightness of an image may increase due to digital gain. In this case, as an average offset of a plurality of pieces of decompressed data DDT respectively corresponding to a plurality of pieces of image data IDT decreases, a difference in brightness in a generated image may be reduced.

The ISP 220 may receive the decompressed data DDT from the decoder 210, perform image processing on the decompressed data DDT, and generate the restored data RDT. The ISP 220 may output the restored data RDT to the display 300.

The display 300 may display various content (e.g., text, images, videos, icons, or symbols) to a user based on the restored data RDT received from the image processing device 200. For example, the display 300 may include a liquid crystal display (LCD), a light-emitting diode (LED) display, an organic light-emitting diode (OLED) display, a microelectromechanical systems (MEMS) display, or an electronic paper display.

The image processing device 200 may further include a memory. The memory may be a storage for storing data and may store, for example, an operating system (OS), various programs, and various data (e.g., image data). The memory may be a volatile memory, such as dynamic random access memory (RAM) (DRAM) or static RAM (SRAM), or a non-volatile memory, such as phase change RAM (PRAM), resistive RAM (ReRAM), or flash memory. The memory may receive the compressed data CDT from the second interface 230 and store the compressed data CDT, and the decoder 210 may receive the compressed data CDT from the memory and generate the decompressed data DDT.

Although FIG. 1 illustrates that the image processing system 10 includes the camera assembly 100, the image processing device 200, and the display 300, the disclosure is not limited thereto. For example, the image processing system 10 may be implemented to include only some of the camera assembly 100, the image processing device 200, and the display 300 or to include a plurality of camera assemblies 100. In addition, although FIG. 1 illustrates the decoder 210 and the ISP 220 as separate components, the disclosure is not limited thereto. For example, the ISP 220 may be implemented to include the decoder 210. According to some embodiments, the decoder 210 and the image processing device 200 including the decoder 210 may generate at least two pieces of compensation data and generate decompressed data by selecting any one piece of compensation data from among the at least two pieces of compensation data, thereby reducing a difference in brightness in a final image.

FIG. 2A is a diagram illustrating a pixel array according to an embodiment. FIG. 2B is a diagram illustrating representative pixel values respectively corresponding to pixel groups included in the pixel array of FIG. 2A, according to an embodiment.

A pixel array 111a of FIG. 2A may correspond to the pixel array 111 of FIG. 1.

The pixel array 111a may include a plurality of pixels PX11 to PX88 arranged in a matrix form. FIGS. 2A and 2B are described with reference to FIG. 1.

The image sensor 110 of FIG. 1 may include the pixel array 111a. The image sensor 110 (FIG. 1) may generate a plurality of pieces of image data IDT (FIG. 1) respectively corresponding to pixel signals generated from the plurality of pixels PX11 to PX88 included in the pixel array 111a.

The pixel array 111a may further include a plurality of color filters arranged to respectively correspond to the plurality of pixels PX11 to PX88. A color filter may be applied in the form of a Bayer color filter. Half of pixels included in the Bayer color filter may detect a green signal, half of the remaining pixels may detect a red signal, and the other half of the remaining pixels may detect a blue signal. For example, the Bayer color filter may have a configuration in which cells having a 2×2 size and respectively including a red pixel, a blue pixel, and two green pixels are repeatedly arranged. In another example, the Bayer color filter may have a configuration in which cells having a 2×2 size and respectively including a red pixel, a blue pixel, and two wide green pixels are repeatedly arranged. According to an embodiment, the Bayer color filter may be an RGB color filter in which a green filter is arranged in two pixels among four pixels, and a blue filter and a red filter are respectively arranged in the remaining two pixels.

However, the type of color filter is not limited to the above-described examples. The color filter may have a configuration in which a plurality of adjacent pixels respectively corresponding to reference colors are repeatedly arranged. Referring to FIG. 2A, the color filter may have a configuration including first green pixels G1 (i.e., the pixels PX11, PX12, PX21, and PX22) arranged in a 2×2 cell, red pixels R (i.e., the pixels PX13, PX14, PX23, and PX24) arranged in a 2×2 cell, blue pixels B (i.e., the pixels PX31, PX32, PX41, and PX42) arranged in a 2×2 cell, and second green pixels G2 (i.e., the pixels PX33, PX34, PX43, and PX44) arranged in a 2×2 cell. Such a pattern may be referred to as a Tetra pattern. The above-described pattern is an example, and the disclosure is not limited thereto. For example, a plurality of pixels included in the image sensor according to some embodiments may be arranged in a Nona pattern in which color patterns indicating the same color are arranged in a 3×3 cell.

As described above, the image sensor 110 of FIG. 1 may include the pixel array 111a. The image sensor 110 (FIG. 1) may generate pieces of image data IDT (FIG. 1) respectively corresponding to pixel values based on pixel signals generated from the plurality of pixels PX11 to PX88 included in the pixel array 111a. The pieces of image data IDT (FIG. 1) respectively corresponding to pixel signals generated from the plurality of pixels PX11 to PX88 may include information on a reference color (e.g., red, blue, first green, second green, etc.) corresponding to each pixel. The encoder 120 (FIG. 1) may receive the image data IDT (FIG. 1) and compress the received image data IDT (FIG. 1) in units of pixel groups. A pixel group may refer to a group composed of pixels corresponding to the same reference color and arranged adjacent to each other. For example, referring to FIG. 2A, a first pixel group PG1 may include the first green pixels G1 (i.e., the pixels PX11, PX12, PX21, and PX22), a second pixel group PG2 may include the first green pixels G1 (i.e., the pixels PX15, PX16, PX25, and PX26), and a third pixel group PG3 may include the first green pixels G1 (i.e., the pixels PX51, PX52, PX61, and PX62). For convenience of description, FIG. 2A only illustrates pixel groups including the first green pixel G1. However, based on the above descriptions, a pixel group including four adjacent red pixels R (i.e., the pixels PX13, PX14, PX23, and PX24), and a pixel group including four adjacent blue pixels B (i.e., the pixels PX31, PX32, PX41, and PX42) may be understood.

Although FIG. 2A illustrates a pixel array of an RGB color scheme, the disclosure is not limited thereto. For example, a cyan, yellow, green, and magenta (CYGM) color filter scheme in which cyan, yellow, green, and magenta color filters are arranged in at least one pixel may be applied. In addition, a cyan, yellow, magenta, and key (CYMK) color filter scheme may be applied. In the disclosure, for convenience of description, a Bayer pattern is described as an example. However, the disclosure is not limited to the Bayer pattern, and it is to be understood that color filters including white or yellow or having various patterns in which two or more color regions are merged may be applied.

In addition, although it has been described with reference to FIG. 2A that image data includes reference color information (e.g., RGB information), the disclosure is not limited thereto. The image sensor 110 may convert RGB information of each of a plurality of pixels into YUV information including information on luminance and color difference through color space conversion, and thus, the image data may include the YUV information corresponding to each pixel.

In addition, the image data including the YUV information may also be compressed in units of pixel groups, as in the above-described embodiment. However, because the image data including the YUV information does not include reference color information, the pixel groups may be classified based only on the positions of pixels.

Referring to FIG. 2A, the pixel array 111a may include the plurality of pixels PX11 to PX88 arranged in a Tetra pattern. Hereinafter, for convenience of description, it is assumed that image data generated from the pixel array 111a includes reference color information. The pixel array 111a may include the first green pixels G1 and the first to third pixel groups PG1, PG2, and PG3 adjacent to each other. For example, the first pixel group PG1 may include four first green pixels G1 (i.e., the pixels PX11, PX12, PX21, and PX22), the second pixel group PG2 may include four first green pixels G1 (i.e., the pixels PX15, PX16, PX25, and PX26), and the third pixel group PG3 may include four first green pixels G1 (i.e., the pixels PX51, PX52, PX61, and PX62).

The image sensor 110 (FIG. 1) according to some embodiments may output the image data IDT (FIG. 1) considering the reference color information or output the image data IDT (FIG. 1) regardless of a reference color. For example, the image sensor 110 (FIG. 1) may, considering the reference color information, output the image data IDT (FIG. 1) corresponding to the first pixel group PG1 including the first green pixel G1, output the image data IDT (FIG. 1) corresponding to the second pixel group PG2 including the first green pixel G1, and then output the image data IDT (FIG. 1) corresponding to the third pixel group PG3 including the first green pixel G1. However, the image sensor 110 (FIG. 1) may output the image data IDT (FIG. 1) in order according to the positions of pixels, without considering the reference color information. Accordingly, when the image sensor 110 (FIG. 1) outputs the image data IDT (FIG. 1) considering the reference color information, the red pixels R (i.e., the pixels PX13, PX14, PX23, and PX24) may be positioned between the first pixel group PG1 and the second pixel group PG2. However, the image sensor 110 (FIG. 1) may output the image data IDT (FIG. 1) corresponding to the first pixel group PG1 and output the image data IDT (FIG. 1) corresponding to the second pixel group PG2. Accordingly, the two pieces of image data IDT (FIG. 1) respectively corresponding to the first pixel group PG1 and the second pixel group PG2 may be referred to as two consecutive pieces of image data IDT (FIG. 1). Hereinafter, for convenience of description, it is described that the image sensor 110 (FIG. 1) outputs the image data IDT (FIG. 1) considering the reference color information, but the disclosure is not limited thereto.

Referring to FIG. 2B, the encoder 120 of FIG. 1 may determine first to third representative pixel values RP1, RP2, and RP3 of the first pixel group PG1, the second pixel group PG2, and the third pixel group PG3, respectively. The encoder 120 of FIG. 1 may generate, based on the first to third representative pixel values RP1, RP2, and RP3 of the first pixel group PG1, the second pixel group PG2, and the third pixel group PG3, respectively, the compressed data CDT (FIG. 1) by compressing the pieces of image data IDT (FIG. 1) respectively corresponding to the first pixel group PG1, the second pixel group PG2, and the third pixel group PG3. A representative pixel value may be an average pixel value of pixels included in a pixel group, a median pixel value of the pixels included in the pixel group, or a pixel value of a pixel at a fixed position in the pixel group. For example, the first representative pixel value RP1, which is the representative pixel value of the first pixel group PG1, may be an average value of pixel values respectively corresponding to the pixels PX11, PX12, PX21, and PX22 included in the first pixel group PG1. Similarly, the second representative pixel value RP2, which is the representative pixel value of the second pixel group PG2, may be an average value of pixel values respectively corresponding to the pixels PX15, PX16, PX25, and PX26 included in the second pixel group PG2, and the third representative pixel value RP3, which is the representative pixel value of the third pixel group PG3, may be an average value of pixel values respectively corresponding to the pixels PX51, PX52, PX61, and PX62 included in the third pixel group PG3.

Although the above-described examples have been described with reference to pixel groups including the first green pixel G1, the above descriptions may apply to pixel groups including the second green pixel G2, the blue pixel B, and the red pixel R.

According to some embodiments, the encoder 120 (FIG. 1) may sequentially compress representative pixel values of pixel groups corresponding to the same reference color to generate pieces of compressed data CDT (FIG. 1) respectively corresponding to the representative pixel values, and the decoder 210 (FIG. 1) may generate pieces of decompressed data DDT (FIG. 1) by sequentially decompressing the pieces of compressed data CDT (FIG. 1) corresponding to the same reference color. For example, referring to FIG. 2B, according to some embodiments, the encoder 120 (FIG. 1) may generate the compressed data CDT (FIG. 1) by compressing the first representative pixel value RP1, generate the compressed data CDT (FIG. 1) by compressing the second representative pixel value RP2, and then generate the compressed data CDT (FIG. 1) by compressing the third representative pixel value RP3. The decoder 210 (FIG. 1) may generate the decompressed data DDT (FIG. 1) by decompressing the compressed data CDT (FIG. 1) corresponding to the first representative pixel value RP1, generate the decompressed data DDT (FIG. 1) by decompressing the compressed data CDT (FIG. 1) corresponding to the second representative pixel value RP2, and then generate the decompressed data DDT (FIG. 1) by decompressing the compressed data CDT (FIG. 1) corresponding to the third representative pixel value RP3.

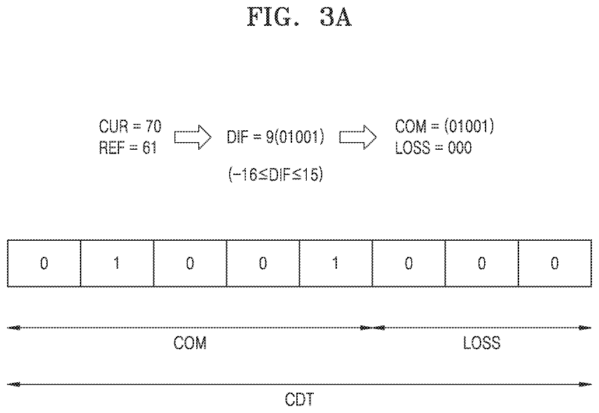

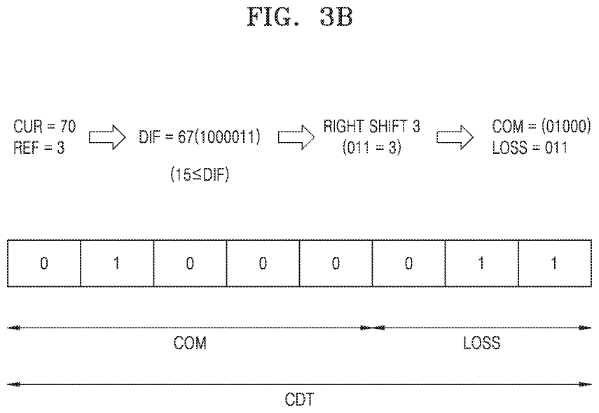

FIGS. 3A and 3B are diagrams illustrating a method of generating compressed data and a configuration of the compressed data, according to an embodiment.

Referring to FIGS. 3A and 3B, the compressed data CDT may include comparison data COM and loss data LOSS. FIGS. 3A and 3B are described with reference to FIGS. 1 and 2B.

Referring to FIGS. 3A and 3B, the encoder 120 of FIG. 1 may generate difference data DIF based on current data CUR and reference data REF, and generate, based on the difference data DIF, the compressed data CDT composed of the comparison data COM and the loss data LOSS. The current data CUR may be a representative pixel value of a pixel group corresponding to the image data IDT (FIG. 1) received by the encoder 120 (FIG. 1), and the reference data REF may be a representative pixel value of a pixel group corresponding to another piece of image data IDT (FIG. 1) received by the encoder 120 (FIG. 1) at an earlier time than the aforementioned piece of image data IDT (FIG. 1). For example, referring to FIG. 2B, the second representative pixel value RP2 (FIG. 2B) may be an average of pixel values of pixels included in the second pixel group PG2 (FIG. 2B), and the encoder 120 (FIG. 1) may compress the second representative pixel value RP2 using the first representative pixel value RP1 (FIG. 2B). In this case, the second pixel group PG2 (FIG. 2) may be referred to as a target pixel group, the second representative pixel value RP2 (FIG. 2B) may be referred to as the current data CUR, and the first representative pixel value RP1 (FIG. 2B) may be referred to as the reference data REF. Because the target pixel group and a pixel group that includes pixels of the same color as the target pixel group and has been compressed before the target pixel group are adjacent to each other, it is highly likely that the two pixel groups have similar pixel values. Accordingly, to increase the compression rate, pixel values of the pixel group of the same color that has been compressed before the target pixel group may be used as the reference data REF of the target pixel group.

Referring to FIGS. 3A and 3B, the compressed data CDT may be data composed of a total of 8 bits and including the comparison data COM corresponding to 5 bits and the loss data LOSS corresponding to 3 bits. However, the configuration and number of bits of the compressed data CDT, the number of bits of the comparison data COM, and the number of bits of the loss data LOSS according to some embodiments are not limited thereto.

Referring to FIG. 3A, the current data CUR may be 70 and the reference data REF may be 61. Accordingly, the difference data DIF corresponding to a difference between the current data CUR and the reference data REF may be 9. As described above, the comparison data COM may correspond to 5 bits, and the 5 bits may include 1 bit corresponding to a sign (a leftmost bit of the comparison data COM may indicate the sign, but the disclosure is not limited thereto) and 4 bits for indicating the absolute value of the difference data DIF. Accordingly, a value that can be expressed by the comparison data COM may be from −16 to 15. Because the difference data DIF is 9, the encoder 120 (FIG. 1) may indicate the difference data DIF as the comparison data COM, without shifting the difference data DIF. Because the difference data DIF is not shifted, none of pieces of data of the difference data DIF are lost. Accordingly, the loss data LOSS may be 0. Therefore, the comparison data COM may be 01001 corresponding to 9, and the loss data LOSS may be 000 corresponding to 0. Shifting may refer to moving data to the left or right in units of bits, and shifting directions in the above-described examples and examples to be described below are illustrative, and the disclosure is not limited thereto.

Referring to FIG. 3B in comparison with FIG. 3A, the current data CUR may be 70 and the reference data REF may be 3. Accordingly, the difference data DIF corresponding to a difference between the current data CUR and the reference data REF may be 67. As described above, the comparison data COM may correspond to 5 bits, and the 5 bits may include 1 bit corresponding to a sign (a leftmost bit of the comparison data COM may indicate the sign, but the disclosure is not limited thereto) and 4 bits for indicating the absolute value of the difference data DIF. Accordingly, a value that can be expressed by the comparison data COM may be from −16 to 15. In this case, because the difference data DIF is 67, the difference data DIF may not be expressed through the comparison data COM. Accordingly, the encoder 120 (FIG. 1) may shift 1000011 (i.e., 67), corresponding to 67, to the right to express the difference data DIF as the comparison data COM. Because 01000 is obtained when 1000011 (i.e., 67) corresponding to the difference data DIF is shifted to the right by 3 bits to express the difference data DIF as the comparison data COM corresponding to 5 bits, the comparison data COM may be 01000. In this case, because 3 bits of bit loss has occurred due to the shifting of the difference data DIF by 3 bits to the right, the loss data LOSS may be 011 (=3) corresponding to the number of bits of the lost data.

The method of generating compressed data and the configuration of the compressed data described with reference to FIGS. 3A and 3B are illustrative, and the disclosure is not limited thereto. The disclosure may include all cases in which data loss occurs due to shifting of data during a compression process.

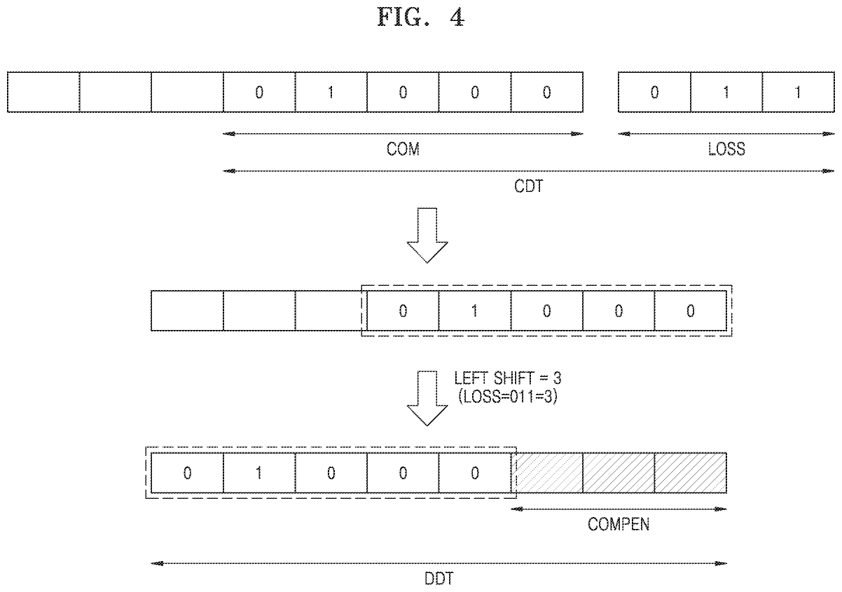

FIG. 4 is a diagram illustrating a method of generating decompressed data, according to an embodiment.

The compressed data CDT of FIG. 4 may be compressed data CDT generated based on the descriptions provided with reference to FIG. 3B.

The decoder 210 (FIG. 1) according to some embodiments may receive the compressed data CDT (FIG. 3B) generated based on the descriptions provided with reference to FIG. 3B. Accordingly, the compressed data CDT of FIG. 4 may correspond to the compressed data CDT of FIG. 3B. However, this is only for convenience of description, and the compressed data CDT according to some embodiments is not limited thereto.

Referring to FIG. 4, as described above, the compressed data CDT may include the comparison data COM of 5 bits and the loss data LOSS of 3 bits. The decoder 210 (FIG. 1) may receive the compressed data CDT and shift the comparison data COM to the left based on the loss data LOSS included in the compressed data CDT. For example, when the loss data LOSS is 011, the decoder 210 (FIG. 1) may shift the comparison data COM by 3 bits to the left and generate the decompressed data DDT by compensating for lost data through compensation data COMPEN corresponding to the number of shifted bits.

For example, the decoder 210 (FIG. 1) may generate the decompressed data DDT (01000000) by adding the compensation data COMPEN (000) to the right of the comparison data COM (01000). Alternatively, the decoder 210 (FIG. 1) may generate the decompressed data DDT (01000011) by further adding the reference data REF (i.e., 011=3) of FIG. 3B to the decompressed data DDT (01000011) to which compensation data COMPEN (000) is added. Because the decompressed data DDT generated in the latter case is 67 (i.e., 01000011), an offset of 3 may occur with respect to the current data CUR (FIG. 3B) of 70. Therefore, according to the above-described process, an offset of 3 may occur. An offset based on each of a plurality of pieces of decompressed data corresponding to a final image may cause a difference in brightness in the final image.

The decoder 210 (FIG. 1) according to some embodiments may generate two different pieces of compensation data and select any one of the two pieces of compensation data, thereby generating decompressed data including the selected piece of compensation data. As a result, an average offset of the plurality of pieces of decompressed data DDT may be reduced. Accordingly, because the average offset thereof is reduced, when a gain is applied to a low-illuminance image, a difference in image brightness caused by an offset may be mitigated or prevented.

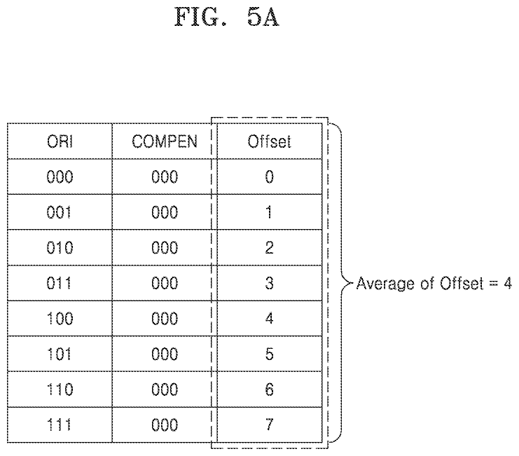

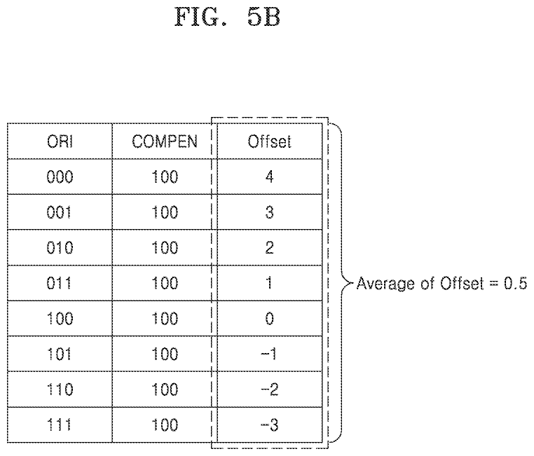

FIGS. 5A and 5B are diagrams illustrating compensation data.

FIGS. 5A and 5B are diagrams illustrating an offset according to the compensation data described with reference to FIG. 4.

Referring to FIGS. 4 and 5A, the compensation data may be 000 (i.e., 0). The decoder may shift the comparison data COM to the left by 3 bits based on the loss data LOSS and generate decompressed data by adding 3 bits of the compensation data COMPEN to the position shifted by 3 bits.

Referring to FIGS. 5A and 3B, the rightmost 3 bits of the difference data DIF (FIG. 3B) may be referred to as original data ORI. For example, referring to FIG. 3B, the original data ORI is 011. Accordingly, the original data ORI may refer to data lost during a compression process by the encoder 120 (FIG. 1). The original data ORI is lost during a data compression process, and when compensating for the lost data during a decompression process, it may be difficult to accurately compensate for the lost data because a value indicated by the original data ORI is unknown.

Referring to FIG. 5A, an offset may vary according to the original data ORI and the compensation data COMPEN. For example, referring to FIG. 3B, because the original data ORI is 011, when the compensation data COMPEN is 000, the offset is 3. Accordingly, it data corresponding to 3 may be lost due to compression and decompression, as described above.

When a value indicated by the loss data LOSS included in each of a plurality of pieces of compressed data is 3 (i.e., when the loss data LOSS included in each of the plurality of pieces of compressed data is the same), the original data ORI may be 3 bits. Accordingly, the original data ORI may have a value of 0 to 7. In this case, when the compensation data COMPEN is 000, an offset based on each of pieces of decompressed data respectively corresponding to the plurality of pieces of compressed data may have a value of 0 to 7, according to the value of the original data ORI. Accordingly, when the loss data LOSS is 3 and the compensation data COMPEN is 000, an average offset based on the plurality of pieces of decompressed data may be 4.

The original data ORI may be lost in a process of compressing image data by the encoder 120 (FIG. 1), and it may be difficult to equally restore the lost original data ORI each time. Accordingly, the decoder 210 (FIG. 1) according to some embodiments may generate arbitrary compensation data and use the compensation data to perform compensation for the lost original data ORI, thereby generating decompressed data.

Referring to FIGS. 4 and 5B, the compensation data according to the comparative example may be 100 (i.e., 4). The decoder may shift the comparison data COM to the left by 3 bits based on the loss data LOSS and generate decompressed data by adding 3 bits of the compensation data COMPEN to the position shifted by 3 bits.

Referring to FIGS. 5B and 3B, the rightmost 3 bits of the difference data DIF (FIG. 3B) may be referred to as original data ORI. Accordingly, the original data ORI may refer to data lost during a compression process by the encoder 120 (FIG. 1).

Referring to FIG. 5B, an offset may vary according to the original data ORI and the compensation data COMPEN. For example, referring to FIG. 3B, because the original data ORI is 011, when the compensation data COMPEN is 100, the offset is 1. Accordingly, data corresponding to 1 may be lost due to compression and decompression, as described above.

When a value represented by the loss data LOSS included in each of a plurality of pieces of compressed data is 3 (i.e., when the loss data LOSS included in each of the plurality of pieces of compressed data is the same), the original data ORI is 3 bits. Accordingly, the original data ORI has a value of 0 to 7. In this case, when the compensation data COMPEN is 100, an offset based on each of pieces of decompressed data respectively corresponding to the plurality of pieces of compressed data may have a value of −3 to 4, according to the value of the original data ORI. Accordingly, when the loss data LOSS is 3 and the compensation data COMPEN is 100, an average offset based on the plurality of pieces of decompressed data may be 0.5.

Comparing FIGS. 5A and 5B, an average offset may be smaller when the compensation data COMPEN is 100 (i.e., 4) than when the compensation data COMPEN is 000 (i.e., 0). The decoder may reduce the average offset by generating appropriate compensation data COMPEN based on the loss data LOSS. For example, the appropriate compensation data COMPEN may be a median among values that may be expressed by the number of bits indicated by the loss data LOSS. When the loss data LOSS is 011 (i.e., 3), a value that may be expressed by 3 bits may be from 0 to 7 and a median value of 0 to 7 may be 3 or 4. Thus, in the case of using one piece of compensation data, an average offset may be the smallest when the compensation data is 3 or 4.

However, even when the decoder uses appropriate compensation data COMPEN, as described above, the average offset may always be 0.5 or more. When digital gain is applied to image data indicating a low-illuminance image to increase the brightness of the low-illuminance image, a difference in effect of the digital gain due to an offset may occur, and thus, a difference in brightness may occur in a final image. Accordingly, by reducing the average offset to less than 0.5 through the decoder 210 (FIG. 1) and the image processing device 200 (FIG. 1) according to some embodiment, as described below, the above issue may be prevented or mitigated.

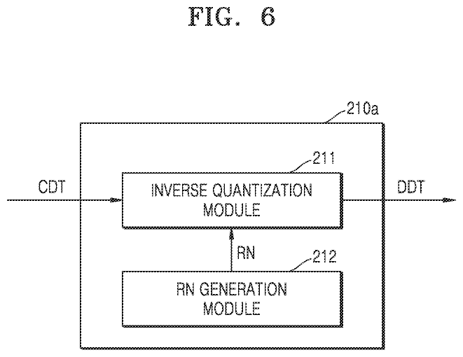

FIG. 6 is a diagram illustrating a decoder according to an embodiment.

Referring to FIG. 6, a decoder 210a according to some embodiments may include an inverse quantization module 211 and a random number generation module 212 (shown and described as the “RN generation module”). The decoder 210a may correspond to the decoder 210 of FIG. 1, and thus, repeated descriptions thereof may be omitted.

The inverse quantization module 211 may receive the compressed data CDT and a random number RN generated by the RN generation module 212. The inverse quantization module 211 may generate at least two different pieces of compensation data based on loss data included in the received compressed data CDT and select any one piece of compensation data from among the at least two different pieces of compensation data based on the received random number RN. The inverse quantization module 211 may generate the decompressed data DDT based on the compressed data CDT and the selected piece of compensation data.

The RN generation module 212 may generate the random number RN and output the random number RN to the inverse quantization module 211. For example, the RN generation module 212 may be a linear feedback shift register (LFSR) and generate the random number RN of 1 bit. However, the disclosure is not limited thereto, and the RN generation module 212 may include other configurations and methods capable of generating the random number RN, and the random number RN may be 1 bit or more.

The RN generation module 212 according to some embodiments may generate the random number RN such that the inverse quantization module 211 selects different pieces of compensation data when decompressing each of two consecutive pieces of compressed data having the same loss data. For example, when the decoder 210a decompresses first compressed data and second compressed data that are consecutive and have the same loss data, the RN generation module 212 may generate the random number RN (e.g., 0) such that the inverse quantization module 211 selects first compensation data when decompressing the first compressed data, and generate the random number RN (e.g., 1) such that the inverse quantization module 211 selects second compensation data when decompressing the second compressed data. Accordingly, the decoder 210a may decompress, based on the generated random number RN, the first compressed data and the second compressed data based on different pieces of compensation data.

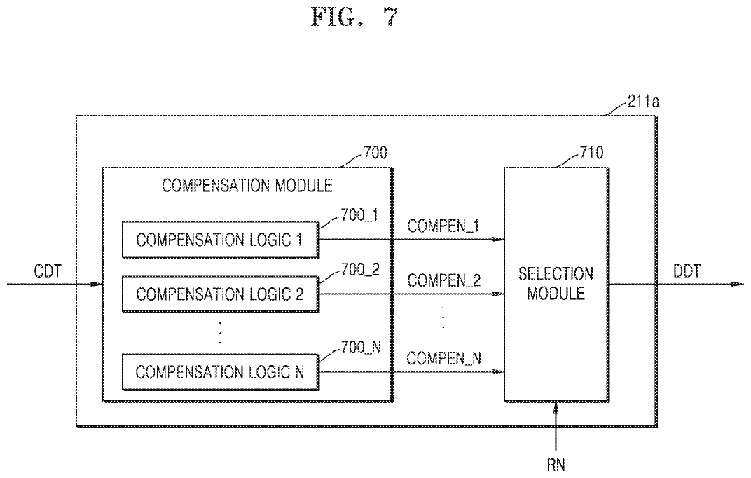

FIG. 7 is a diagram illustrating an inverse quantization module according to an embodiment.

Referring to FIG. 7, an inverse quantization module 211a may include a compensation module 700 and a selection module 710. The compensation module 700 may include a plurality of compensation logics (i.e., first to Nth compensation logics 700_1 to 700_N). The inverse quantization module 211a may correspond to the inverse quantization module 211 of FIG. 6, and thus, repeated descriptions thereof may be omitted.

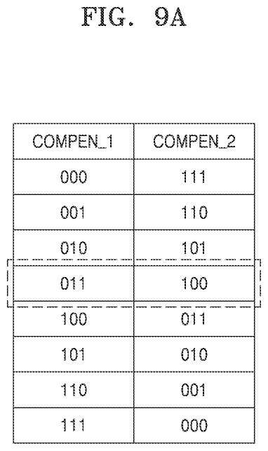

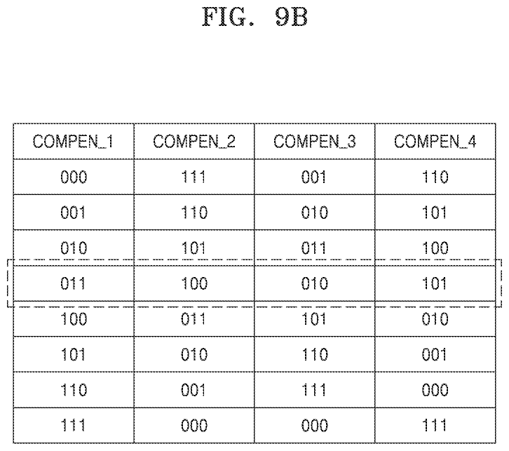

The compensation module 700 may receive the compressed data CDT and generate N pieces of compensation data (i.e., first to Nth compensation data COMPEN_1 to COMPEN_N) based on loss data included in the compressed data CDT. The compensation module 700 may receive the compressed data CDT and generate N pieces of compensation data (i.e., the first to Nth compensation data COMPEN_1 to COMPEN_N) from N compensation logics (i.e., the first to Nth compensation logics 700_1 to 700_N) respectively, based on the loss data included in the compressed data CDT. N may be an integer of 2 or more. For example, referring to FIG. 9A, the compensation module 700 may generate the first compensation data COMPEN_1 and the second compensation data COMPEN_2 through the first compensation logic 700_1 and the second compensation logic 700_2, respectively, based on the loss data included in the compressed data CDT. Also, referring to FIG. 9B to be described below, the compensation module 700 may generate the first compensation data COMPEN_1, the second compensation data COMPEN_2, the third compensation data COMPEN_3, and the fourth compensation data COMPEN_4 using the first compensation logic 700_1, the second compensation logic 700_2, the third compensation logic, and the fourth compensation logic, respectively, based on the loss data included in the compressed data CDT.

The selection module 710 may receive the N pieces of compensation data (i.e., the first to Nth compensation data COMPEN_1 to COMPEN_N) from the compensation module 700, receive the random number RN from the random number generation module 212 (FIG. 6), and output the decompressed data DDT. The selection module 710 may receive the N pieces of compensation data (i.e., the first to Nth compensation data COMPEN_1 to COMPEN_N), select any one piece of compensation data from among the N pieces of compensation data (i.e., the first to Nth compensation data COMPEN_1 to COMPEN_N) based on the received random number RN, and output the decompressed data DDT generated based on the selected piece of compensation data. For example, referring to FIG. 9A, the compensation module 700 may generate the first compensation data COMPEN_1 and the second compensation data COMPEN_2 through the first compensation logic 700_1 and the second compensation logic 700_2, respectively, based on the loss data included in the compressed data CDT, where the first compensation data COMPEN_1 may be 011, and the second compensation data COMPEN_2 may be 100. The selection module 710 may receive the first compensation data COMPEN_1, the second compensation data COMPEN_2, and the random number RN, and select any one of the first compensation data COMPEN_1 and the second compensation data COMPEN_2 based on the random number RN. For example, the random number RN may be 1 bit, and the selection module 710 may select the first compensation data COMPEN_1 when the random number RN is 0 and select the second compensation data COMPEN_2 when the random number RN is 1.

Accordingly, the decoder 210 (FIG. 1) and the image processing device 200 (FIG. 1) according to some embodiments may generate at least two different pieces of compensation data and select any one of the at least two pieces of compensation data based on a random number, thereby reducing an average offset.

The selection module 710 according to some embodiments may be a multiplexer but is not limited thereto. The selection module 710 may receive a plurality of pieces of compensation data (i.e., the first to Nth compensation data COMPEN_1 to COMPEN_N), and output any one piece of compensation data from among the plurality of pieces of compensation data (i.e., the first to Nth compensation data COMPEN_1 to COMPEN_N) based on the random number RN. The inverse quantization module 211a may generate the decompressed data DDT based on the output piece of compensation data and the compressed data CDT.

The selection module 710 according to some embodiments may output the decompressed data DDT based on the selected piece of compensation data. For example, referring to the above-described examples and FIGS. 4 and 7 together, the selection module 710 may receive the first compensation data COMPEN_1 indicating 011, the second compensation data COMPEN_2 indicating 100, and the random number RN indicating 1. The selection module 710 may select the second compensation data COMPEN_2 based on the random number RN and generate the decompressed data DDT having a value of 01000100 based on the selected second compensation data COMPEN_2 (see FIG. 4). Although the decompressed data DDT described above is described as being composed of the comparison data COM (FIG. 4) and the compensation data COMPEN (FIG. 4), the decompressed data DDT according to some embodiments is not limited thereto. The decompressed data DDT may refer to data obtained by additionally adding the reference data REF thereto. For example, referring to FIG. 4 and the above-described examples, the decompressed data DDT may be 01000100, or 01000111, which is a value obtained by adding 01000100 and the reference data REF (FIG. 3) of 011. In this case, because the current data CUR (FIG. 3B), which is the original data value, is 70 (i.e., 1000011) and the decompressed data DDT, to which the reference data REF (FIG. 3B) has been added, is 71 (i.e., 1000111), an offset of 1 may occur during compression and decompression processes.

In decompressing a plurality of pieces of compressed data including the same loss data, the decoder 210 (FIG. 1) and the image processing device 200 (FIG. 1) according to some embodiments may equally select, based a random number, at least two different pieces of compensation data generated based on the loss data, thereby reducing an average offset to less than 0.5.

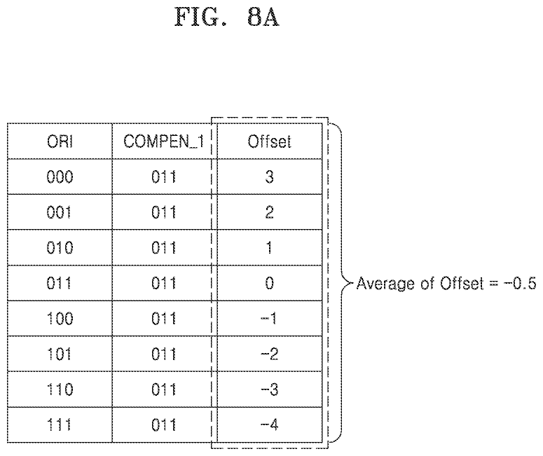

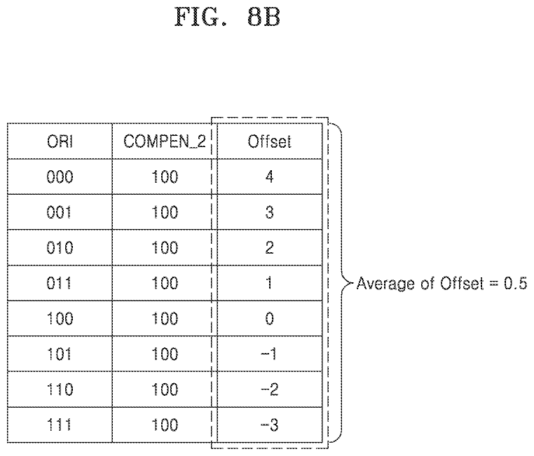

FIGS. 8A and 8B are diagrams illustrating compensation data according an embodiment.

FIGS. 8A and 8B are described with reference to FIG. 7.

FIG. 8A illustrates an average offset (i.e., −0.5) when the first compensation data COMPEN_1 is 011 (i.e., 3), according to an embodiment, and FIG. 8B illustrates an average offset (i.e., 0.5) when the second compensation data COMPEN_2 is 100 (i.e., 4), according to an embodiment. Accordingly, as described above, when the decoder or the image processing device generates decompressed data using only one piece of compensation data among the first compensation data COMPEN_1 and the second compensation data COMPEN_2, an average offset may not be less than 0.5.

Referring to FIGS. 7, 8A, and 8B, the compensation module 700 of FIG. 7 may generate the first compensation data COMPEN_1 and the second compensation data COMPEN_2 based on the loss data included in the received compressed data CDT. The selection module 710 may select any one piece of compensation data from among the first compensation data COMPEN_1 and the second compensation data COMPEN_2 based on the random number RN. When the above-described process is performed on each of a plurality of pieces of compressed data including the same loss data, each of a plurality of pieces of decompressed data respectively corresponding to the plurality of pieces of compressed data may be generated based on the first compensation data COMPEN_1 or the second compensation data COMPEN_2. Accordingly, when a plurality of pieces of decompressed data are generated using at least two different pieces of compensation data, an average offset may be smaller than when a plurality of pieces of decompressed data are generated using only one piece of compensation data. According to an embodiment, the number of times the first compensation data COMPEN_1 is selected and the number of times the second compensation data COMPEN_2 is selected may be similar to each other.

For example, when the decoder decompresses a total of 16 pieces of compressed data including 2 pieces of compressed data corresponding to each of 8 pieces of the original data ORI of FIG. 8A using the first compensation data COMPEN_1, an average offset is −0.5. However, when the decoder 210 (FIG. 1) or the image processing device 200 (FIG. 1) according to some embodiments decompresses a total of 16 pieces of compressed data including 2 pieces of compressed data corresponding to each of 8 pieces of the original data ORI of FIG. 8A by selecting any one piece of compensation data from among the first compensation data COMPEN_1 and the second compensation data COMPEN_2, an average offset may be 0. Referring to FIGS. 8A and 8B together, when selecting any one piece of compensation data from among the two pieces of compensation data described above, 8 pieces among the 16 pieces of decompressed data respectively corresponding to the 16 pieces of compressed data may be generated based on the first compensation data COMPEN_1, and the remaining 8 pieces may be generated based on the second compensation data COMPEN_2.

As described above, the decoder 210 (FIG. 1) or the image processing device 200 (FIG. 1) may select any one piece of compensation data from among the first compensation data COMPEN_1 and the second compensation data COMPEN_2 based on a random number and select at least two different pieces of compensation data based on the random number, thereby reducing an average offset to less than 0.5.

FIGS. 9A and 9B are diagrams illustrating complementary compensation data pairs according to an embodiment.

Referring to FIG. 9A, the decoder 210 of FIG. 1 may generate two different pieces of compensation data. The decoder 210 of FIG. 1 may generate the first compensation data COMPEN_1 and the second compensation data COMPEN_2 having a complementary relationship with each other. A complementary relationship as referred to herein may include bits included in each of two pieces of compensation data composed of K bits being different from their corresponding bits. K may be an integer of 1 or more. For example, referring to FIG. 9A, when the first compensation data COMPEN_1 and the second compensation data COMPEN_2 are each 3 bits and the first compensation data COMPEN_1 is 000, the second compensation data COMPEN_2 having a complementary relationship with the first compensation data COMPEN_1 is 111. 000 and 111 have different first, second, and third bits corresponding to each other. Similarly, when the first compensation data COMPEN_1 is 011, the second compensation data COMPEN_2 having a complementary relationship with the first compensation data COMPEN_1 is 100. As described above, the decoder 210 (FIG. 1) according to some embodiments may generate two pieces of compensation data having a complementary relationship with each other and equally select the two pieces of compensation data based on a random number, thereby reducing an average offset.

Referring to the above-described examples and FIG. 9A, when the first compensation data COMPEN_1 and the second compensation data COMPEN_2 are complementary to each other and a difference between values indicated by the first compensation data COMPEN_1 and the second compensation data COMPEN_2 is 1, an average offset may be effectively reduced. For example, when the first compensation data COMPEN_1 is 011 (i.e., 3) and the second compensation data COMPEN_2 is 100 (i.e., 4), the average offset may be effectively reduced.

Referring to FIG. 9B, the decoder 210 of FIG. 1 may generate four different pieces of compensation data. The decoder 210 of FIG. 1 may generate the first compensation data COMPEN_1 and the second compensation data COMPEN_2 having a complementary relationship with each other and generate the third compensation data COMPEN_3 and the fourth compensation data COMPEN_4 having a complementary relationship with each other. That is, two complementary compensation data pairs may be generated. For example, referring to FIG. 9B, the decoder 210a (FIG. 6) according to some embodiments may generate 011 and 100, which are complementary to each other, as the first compensation data COMPEN_1 and the second compensation data COMPEN_2, respectively, and generate 010 and 101, which are complementary to each other, as the third compensation data COMPEN_3 and the fourth compensation data COMPEN_4, respectively. The decoder 210 (FIG. 1) may select any one piece of compensation data from among the first compensation data COMPEN_1, the second compensation data COMPEN_2, the third compensation data COMPEN_3, and the fourth compensation data COMPEN_4, based on a random number. In this case, the random number for selecting any one of the four pieces of compensation data may be composed of 2 bits. For example, the decoder 210 (FIG. 1) may select the first compensation data COMPEN_1 when the random number RN (FIG. 6) generated by the RN generation module 212 (FIG. 6) is 00, select the second compensation data COMPEN_2 when the random number RN (FIG. 6) is 01, select the third compensation data COMPEN_3 when the random number RN (FIG. 6) is 10, and select the fourth compensation data COMPEN_4 when the random number RN (FIG. 6) is 11. In this case, the number of times the first compensation data COMPEN_1 is selected and the number of times the second compensation data COMPEN_2 is selected may be similar to each other, and the number of times the third compensation data COMPEN_3 is selected and the number of times the fourth compensation data COMPEN_4 is selected may be similar to each other. In other words, the decoder 210a (FIG. 6) may similarly select two pieces of compensation data included in a complementary compensation data pair.

The number of pieces of compensation data according to some embodiments is not limited to the above-described examples, and the decoder 210 (FIG. 1) or the image processing device 200 (FIG. 1) according to some embodiments may generate at least one complementary compensation data pair.

Accordingly, the decoder according to some embodiments may generate a random number and select any one piece of compensation data from among at least two pieces of compensation data based on the generated random number, thereby reducing an average offset.

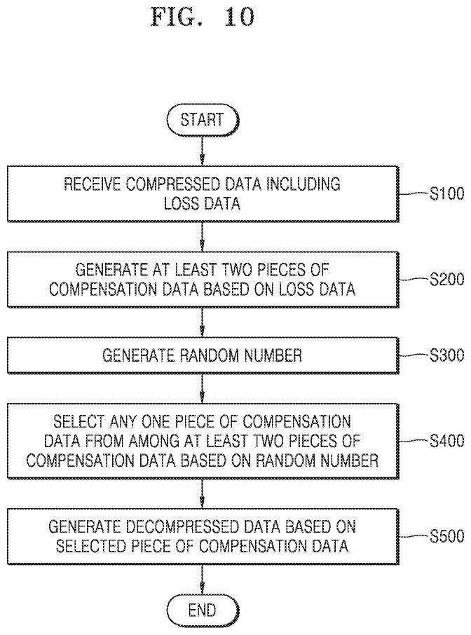

FIG. 10 is a flowchart illustrating a method of generating decompressed data, according to an embodiment. FIG. 10 may be a flowchart illustrating a method, performed by the image processing system 10 of FIG. 1, of decompressing an image. At least one of operations of FIG. 10 may be performed by the decoder 210 (FIG. 1) or the image processing device 200 (FIG. 1).

Referring to the above descriptions, in operation S100, the decoder 210 (FIG. 1) or the image processing device 200 (FIG. 1) according to some embodiments may receive compressed data including loss data. As described above, the loss data may correspond to data lost during a process of compressing the image data IDT (FIG. 1) by the encoder 120 (FIG. 1).

In operation S200, at least two pieces of compensation data may be generated based on the loss data. As described above, the at least two pieces of compensation data may indicate different values and have a complementary relationship with each other. For example, when the loss data is 010 (i.e., 2), first compensation data may be 10 (i.e., 2), and second compensation data may be 01 (i.e., 1). Because corresponding bits of the first compensation data and the second compensation data in the above example are different from each other, the first compensation data and the second compensation data may be said to be complementary to each other.

In operation S300, a random number may be generated. The random number may be generated according to the number of pieces of compensation data generated based on the loss data. For example, when the number of pieces of compensation data generated based on the loss data is 2, the random number may be 1 bit. When the number of pieces of generated compensation data is 4, the random number may be 2 bits, and when the number of pieces of generated compensation data is 8, the random number may be 3 bits.

In operation S400, any one piece of compensation data among the at least two pieces of compensation data may be selected based on the random number. As described above, the decoder 210 (FIG. 1) according to some embodiments may select any one piece of compensation data from among the at least two pieces of compensation data based on the random number. The decoder 210 (FIG. 1) according to some embodiments may generate two pieces of decompressed data by decompressing each of two adjacent pieces of compressed data including the same loss data based on different compensation data.

Accordingly, the decoder 210 (FIG. 1) or the image processing device 200 (FIG. 1) according to some embodiments may generate at least two pieces of compensation data based on one piece of loss data and equally select the at least two pieces of compensation data based on a random number, thereby reducing an average offset of a plurality of pieces of decompressed data to 0.5 or less.

In operation S500, decompressed data may be generated based on the selected piece of compensation data. An average offset of a plurality of pieces of generated decompressed data may be less than 0.5.

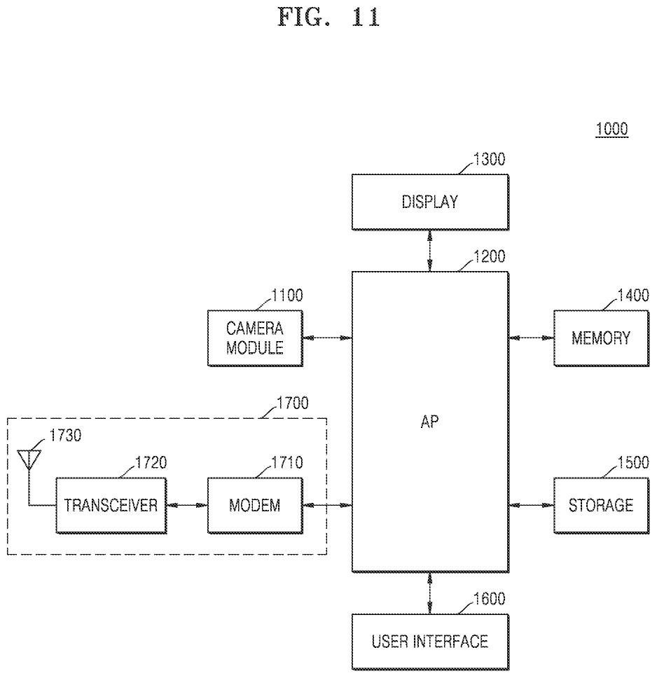

FIG. 11 is a diagram illustrating an electronic device according to an embodiment.

Referring to FIG. 11, the electronic device 1000 may include a camera assembly 1100, an application processor 1200, a display 1300, a memory 1400, a storage 1500, a user interface 1600, and a wireless transceiver 1700. The camera assembly 1100 of FIG. 11 may correspond to the camera assembly 100 of FIG. 1, the display 1300 of FIG. 11 may correspond to the display 300 of FIG. 1, and the application processor 1200 of FIG. 11 may include the image processing device 200 of FIG. 1.

The application processor 1200 may control the overall operation of the electronic device 1000 and may be provided as a system-on-chip (SoC) that drives an application program, an OS, and the like. The application processor 1200 may receive compressed data including loss data from the camera assembly 1100, generate at least two different pieces of compensation data based on the loss data, select any one piece of compensation data from among the at least two different pieces of compensation data based on a random number, and generate decompressed data based on the selected piece of compensation data. In some embodiments, the application processor 1200 may store compressed data in the memory 1400 or the storage 1500.

The memory 1400 may store programs (e.g., instructions) and/or data processed or executed by the application processor 1200. The storage 1500 may be implemented as a nonvolatile memory device, such as a NAND flash or a resistive memory. For example, the storage 1500 may be provided as a memory card (e.g., a multi-media card (MMC), an embedded MMC (eMMC), a secure digital (SD) card, or a micro SD card) or the like. The storage 1500 may store data and/or programs on an execution algorithm for controlling an image processing operation of the application processor 1200, and when an image processing operation is performed, the data and/or programs may be loaded to the memory 1400.

The user interface 1600 may be implemented as various devices capable of receiving a user input, such as a keyboard, a curtain key panel, a touch panel, a fingerprint sensor, and a microphone. The user interface 1600 may receive a user input and provide a signal corresponding to the received user input to the application processor 1200. The wireless transceiver 1700 may include a modem 1710, a transceiver 1720, and an antenna 1730.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like represented by a block or an equivalent indication in the above embodiments including, but not limited to, FIGS. 1, 6, 7, and 11 may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. An image processing device comprising:
an interface configured to receive compressed data obtained by compressing image data corresponding to an output of at least one pixel; and
a decoder configured to:
generate at least two different pieces of compensation data based on loss data included in the compressed data, and
generate decompressed data by decompressing the compressed data based on any one piece of compensation data among the at least two different pieces of compensation data,
wherein the loss data corresponds to data lost due to compression of the image data.

2. The image processing device of claim 1, wherein the decoder is further configured to:
generate a random number, and
select the one piece of compensation data based on the random number.

3. The image processing device of claim 2, wherein the decoder comprises:
a random number generation module configured to generate the random number; and
a selection module configured to:
receive the at least two different pieces of compensation data and the random number; and
output one piece of compensation data from among the at least two different pieces of compensation data based on the random number.

4. The image processing device of claim 3, wherein the random number generation module comprises a linear feedback shift register (LFSR).

5. The image processing device of claim 1, wherein the at least two different pieces of compensation data are complementary.

6. The image processing device of claim 5, wherein a difference between values indicated by the at least two different pieces of compensation data is 1.

7. The image processing device of claim 1, wherein the decoder is further configured to generate even-numbered pieces of compensation data, and
wherein the even-numbered pieces of compensation data are comprise complementary data pairs.

8. The image processing device of claim 7, wherein the decoder is further configured to generate a random number based on the number of the even-numbered pieces of compensation data.

9. The image processing device of claim 1, wherein the interface is further configured to receive a plurality of pieces of compressed data,
wherein the decoder is further configured to generate a plurality of pieces of decompressed data by decompressing each of the plurality of pieces of compressed data, and
wherein an average offset of the plurality of pieces of decompressed data is less than 0.5.

10. An operating method of an image processing device, the operating method comprising:
receiving compressed data comprising loss data corresponding to data lost due to compression of image data;
generating at least two different pieces of compensation data based on the loss data;
generating a random number;
selecting any one piece of compensation data from among the at least two different pieces of compensation data based on the random number; and
generating decompressed data based on the selected one piece of compensation data.

11. The operating method of claim 10, wherein the at least two different pieces of compensation data are complementary.

12. The operating method of claim 10, wherein the receiving the compressed data comprises receiving a plurality of pieces of compressed data,
wherein the generating of the decompressed data comprises generating a plurality of pieces of decompressed data by decompressing each of the plurality of pieces of compressed data, and
wherein an average offset of the plurality of pieces of decompressed data is less than 0.5.

13. The operating method of claim 12, wherein the generating of the decompressed data further comprises:
generating, based on different pieces of compensation data, two pieces of decompressed data comprising the same loss data and respectively corresponding to two adjacent pieces of compressed data.

14. The operating method of claim 12, wherein each of the plurality of pieces of compressed data comprises compressed image data corresponding to at least two adjacent pixels.

15. The operating method of claim 14, wherein the at least two adjacent pixels comprise pixels of a same color.

16. The operating method of claim 10, wherein the random number is generated based on the number of the at least two different pieces of compensation data.

17. A decoder comprising:
a compensation module configured to:
receive compressed data comprising loss data; and
generate first compensation data and second compensation data based on the loss data;
a random number generation module configured to generate a random number based on the loss data; and
a selection module configured to select any one piece of compensation data from among the first compensation data and the second compensation data based on the random number,
wherein the decoder is configured to generate decompressed data based on the selected one piece of compensation data.

18. The decoder of claim 17, wherein the first compensation data is complementary to the second compensation data, and
wherein the decoder is further configured to generate a first piece of decompressed data based on the first compensation data, and generate a second piece of decompressed data based on the second compensation data.

19. The decoder of claim 17, wherein the random number comprises a 1 bit value.

20. The decoder of claim 17, wherein an average offset of a plurality of pieces of decompressed data respectively corresponding to a plurality of pieces of compressed data comprising the same loss data is less than 0.5.
